(19) United States
(12) Patent Application Publication
(10) Pub. No.: US 2002/0118535 A1
(43) Pub. Date: Aug. 29, 2002

(54) Flexible plush lighting apparatus

(76) Inventor: Michael Nostrant, Tarzana, CA (US)

Correspondence Address: Attn: Spyros J. Lazaris, Esq., OPPENHEIMER WOLFF & DONNELLY LLP, Suite 3800, 2029 Century Park East, Los Angeles, CA, 90067, US

(21) Appl. No.: 09/794,708

(22) Filed: Feb. 27, 2001

(51) Int. Cl. F21S 6/00

(52) U.S. Cl. 362/124; 362/189

(57) ABSTRACT

A flexible, plush lighting apparatus that can be bent and twisted such that at least a portion of the apparatus can be wrapped about a person's body or a support structure. The lighting apparatus includes a flexible shaft that may be twisted or otherwise manipulated into various shapes. A decorative cover resembling a plush stuffed toy animal may cover the shaft of the lighting apparatus. The flexible shaft is attached to a lighting unit common in the art having a light bulb, a reflector, a focusing lens and one or more batteries. The lighting unit is disposed within an opening formed in the decorative cover. The flexible shaft of the lighting apparatus comprises an inner, flexible core, enclosed within a resilient, soft, flexible sleeve.

### BACKGROUND OF THE INVENTION

1. Field of the Invention

The invention generally relates to lighting devices and, more particularly, to a flexible, plush flashlight.

2. Description of the Related Art

Flashlights typically include a lighting unit that is attached to a rigid body. The rigid body of a flashlight is used as a handle to allow a user to hold and carry the flashlight, and also as a means to direct the light beam produced to an intended direction. As such, the user is required to utilize at least one hand to hold and point the flashlight. Some flashlight units have been modified to include a relatively flexible body so that a user can wrap the flexible body of the flashlight around an object or one or more body parts, so that both of the user's hands are free.

Some prior art flexible flashlights include a corrugated flexible exterior surface along the body of the flashlight that can be irritating and rough when it is rubbed against the skin of the user. Also, the elongated flexible body of the flashlight resembles a snake and is aesthetically unappealing to a user, especially if the user is a child. Therefore, there is a need for a flexible flashlight that it is physically soft and attractive.

Accordingly, it is one object of the invention to provide a flexible flashlight that is convenient to use. It is another object of the invention to provide a flashlight that is aesthetically pleasing such that it will not frighten children. Also, it is an object of the invention to provide a flashlight that does not irritate the skin during use.

### INVENTION SUMMARY

The present invention is directed to a flexible, plush lighting apparatus that can be bent and twisted such that at least a portion of the apparatus can be wrapped about a support structure, or a person's body parts.

The present invention features a flashlight with a flexible shaft that may be twisted or otherwise manipulated into various shapes. Embodiments of the invention are covered with a decorative cover resembling a plush stuffed toy animal. The flexible shaft, while disposed in the stuffed animal, can be configured in various shapes to provide amusement and enjoyment to the user. The flexibility of the shaft also provides a means for pointing the flashlight's beams to a particular direction. The flexible, plush light of the invention can be wrapped about the neck, arm or leg of a user, for example. It can also be shaped to stand alone upon a supporting surface.

The flexible shaft of the present invention is attached to a lighting unit common in the art consisting of a light bulb, a reflector, a focusing lens and one or more batteries. In accordance with one or more embodiments of the invention, the lighting unit is disposed within an opening formed in the decorative cover. For example, in one embodiment the lighting unit protrudes through an opening in the mouth of a stuffed toy animal.

The flexible shaft of the lighting apparatus comprises an inner, flexible core, enclosed within a resilient, soft, flexible sleeve. The resilience of the sleeve in combination with the plush surface of the decorative cover are appreciated by the user when the light is flexibly wrapped about the user's body parts, or other support structure. The invention may be produced in various sizes. For example, in one embodiment, the invention is configured to be used as a reading light that is attachable to a book or other reading material.

### BRIEF DESCRIPTION OF THE DRAWINGS

FIG. 1 is a perspective view of a flexible, plush light, according to one or more embodiments of the invention;

FIG. 2 is a perspective view of some of the components of the flexible, plush light of FIG. 1;

FIG. 3 is an elevational view, partly in cross-section, of the flexible, plush light of FIG. 1, according to an embodiment of the invention; and

FIG. 4 is an elevational view, partly in cross-section, of a flexible, plush light, according to another embodiment of the invention.

### DETAILED DESCRIPTION OF THE EMBODIMENTS

A flexible, plush light in accordance with the present invention, comprises a decorative cover with a flexible flashlight disposed therein. The flashlight has a durable flexible core overlaid with a soft, resilient material. The decorative cover can be in the shape of a stuffed toy animal. Due to its soft, decorative exterior and flexible features, the plush light of the present invention is an ideal flashlight toy for children and can be easily shaped so that it can be carried about one's person or to alternatively stand alone on a supporting surface or structure. The flexible features of the invention also allow a user to direct the light emanating from the toy's lighting unit on a particular spot.

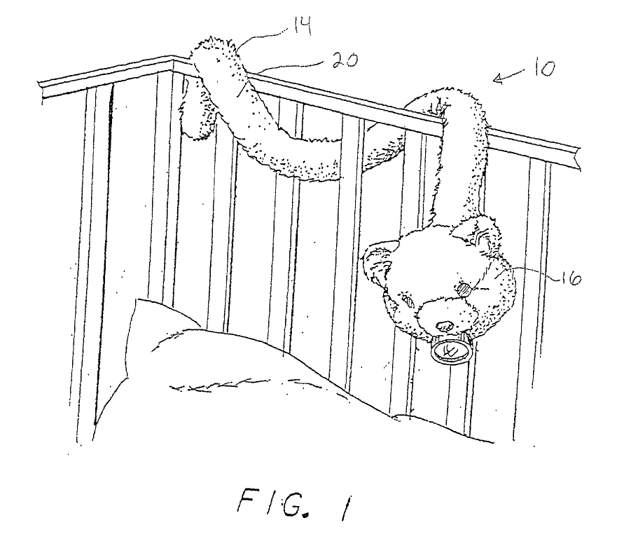

Referring to FIG. 1, a perspective view of flexible, plush light 10 of the present invention is shown in relation to an exemplary use environment. As illustrated in FIG. 1, the body of the flexible, plush light 10 can be configured to adapt to the outer surface of a support structure, such as a bed post, and to direct the light beam produced by the lighting unit of the invention. The aesthetically pleasant cover of the flexible plush light 10, as well as its soft, resilient features, make it suitable for use around young children, for example, to provide lighting for a baby crib, as illustrated in FIG. 1.

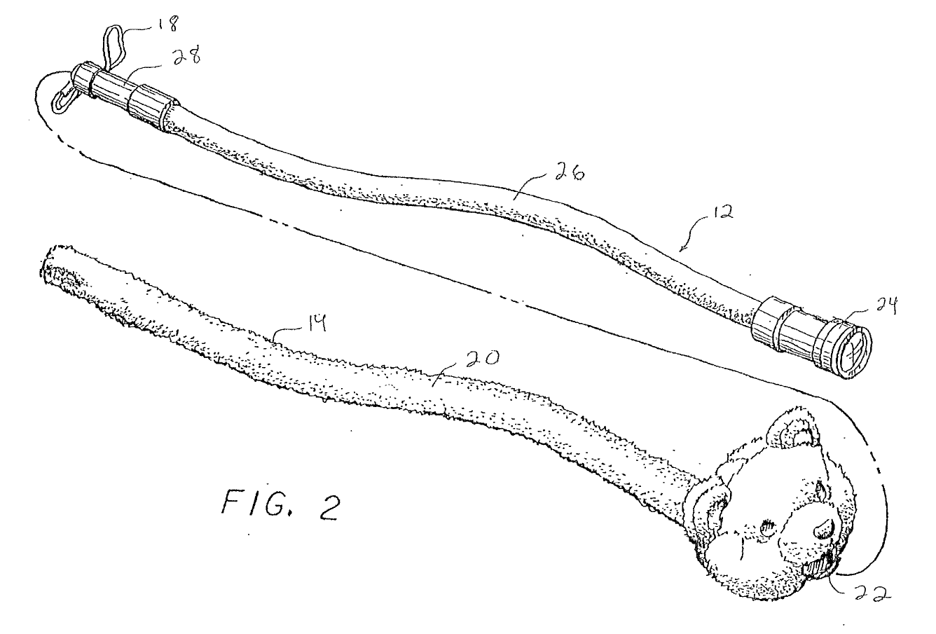

Referring to FIG. 2, the flexible plush light 10 of the present invention comprises a flashlight apparatus 12 and a plush cover 14. The plush cover 14 includes a stuffed, toy head 16, a plush body 20, and an opening 22 that simulates the mouth of the stuffed, toy head 16. The flashlight apparatus 12, shown in FIG. 2, comprises a lighting unit 24, a flexible elongated body 26, and a battery compartment 28. The flashlight apparatus 12 is disposed inside the plush cover 14, such that the lighting unit 24 partially protrudes through the opening 22 when the flexible elongated body 26 is inserted into the plush body 20.

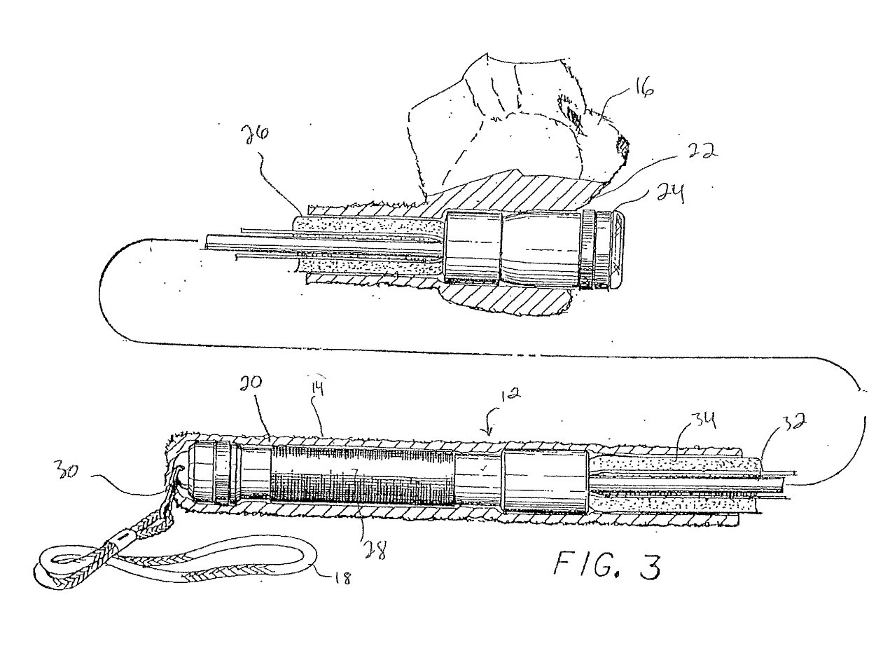

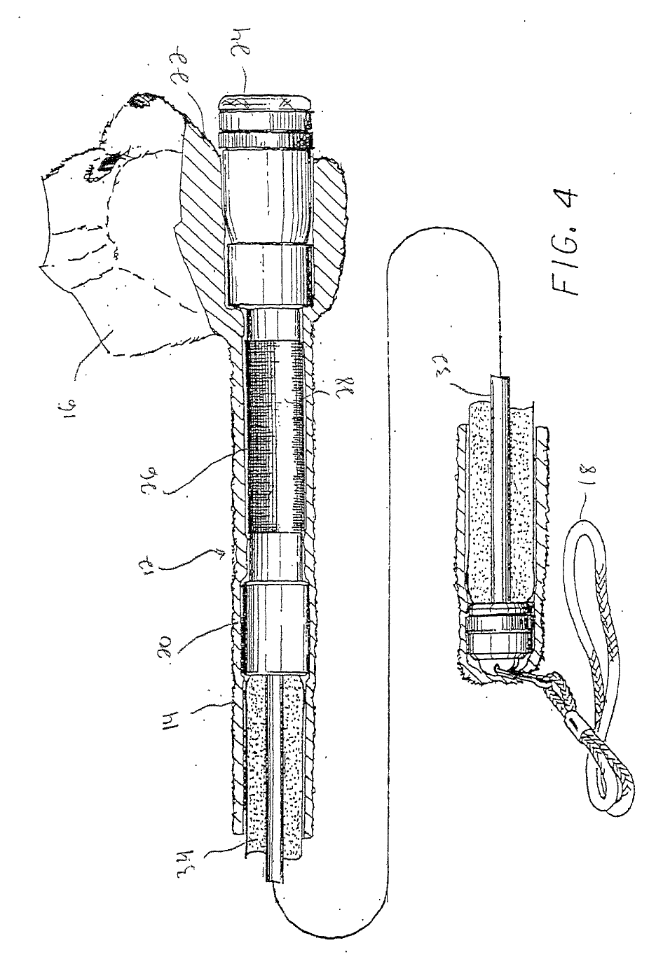

Referring to FIGS. 3 and 4, partially cross-sectional views of one or more embodiments of the invention are illustrated. In one or more embodiments of the invention, in assembly, the flashlight apparatus 12 is inserted into the plush body 20 through the opening 22 such that the illuminating end of the lighting unit 24 remains partially exposed through the opening 22. The plush body 20 fitly and longitudinally covers the flexible elongated body 26 of the flashlight apparatus 12. The flashlight apparatus 12 disposed within the plush decorative cover 14 can be pulled out of the opening 22, so that the batteries enclosed in the battery compartment 28 may be replaced. One or more embodiments of the invention include an access means 30, in the form of a through opening, preferably at the terminal end of the plush body 20, so that the battery compartment 28 is readily accessible through the access means 30. As such, the flexible elongated body 26 need not be fully removed from the plush cover 14, when the batteries are to be replaced.

In one or more embodiments of the invention, the flashlight apparatus 12 includes the lighting unit 24 that comprises a light bulb, a reflector, a lens, an electrical switch and circuitry for electrically connecting the light bulb to the battery compartment 28. The light bulb is generally disposed within a flared reflector to intensify the light that passes through the lens. The light bulb can be a high-intensity micro-subminiature bulb that is powered by one or more AA batteries, for example. In combination with the lens and the reflector, embodiments of the invention may include a spot to flood beam adjusting mechanism for controlling the focus of the light beam that passes through the lens. The adjusting mechanism may also act as a twistable on-and-off switch in some embodiments of the invention. In other embodiments, a common pressure-activated switch may be used to complete a closed electrical circuit configured for delivery of electrical current to the light bulb. The switch may be concealed within the stuffed animal's body parts, for example, under its nose.

As illustrated in FIGS. 3 and 4, the flexible elongated body 26 comprises an inner, flexible core member 32 that is overlaid with resilient, soft material that forms a flexible sleeve 34. The core member 32, in one or more embodiments of the invention, is extruded of engineered plastic that is highly flexible and durable to the point that it can easily conform to sharp bends without breaking or cracking. As a result, the core member 32 can be easily turned, twisted or shaped into many configurations. The sleeve 34 formed about the core member 32 is preferably made of a resilient, soft foam material and provides a bouncy, padded effect when it is overlaid with the plush cover 14. In some embodiments of the invention, the sleeve 34 may be in the form of a coil spring wrapped about the core member 32. In this embodiment, the flexible elongated body 26 can be bent and twisted in different positions and shapes, however, due to the elastic nature of the coil spring, the flexible elongated body 26 will ultimately deflect back to its original position.

Referring to FIGS. 3 and 4, one or more embodiments of the invention are illustrated wherein the battery compartment 28 can be disposed in different locations with respect to the flexible elongated body 26 of the invention. For example, as illustrated in FIG. 3, the battery compartment 28 can be attached to the terminal end of the flexible elongated body 26, opposite to the end where the lighting unit 24 is attached. In other embodiments, the battery compartment 28 is connected to the lighting unit 24, such that the battery compartment 28 is interposed between the lighting unit 24 and the flexible elongated body 26 of the flashlight apparatus 12, as illustrated in FIG. 4. In other embodiments of the invention, the lighting unit 24 may have a self-contained battery compartment.

The plush cover 14 can be designed to include various decorative features. For example, the stuffed toy head 16 can be shaped after the head of a bear, a rabbit, a snake, or any other animal or character. Additionally, the plush body 20 can be formed into shapes other than a simple tubular elongated sleeve. In one or more embodiments of the invention, plush body 20 is shaped to resemble the body of a stuffed animal or character with various body members and openings appropriated to house the flexible elongated body 26 and the lighting unit 24. For example, the plush body 20 can be shaped to resemble the figure of a monkey having a hollow interior and elongated arms, wherein the flexible elongated body 26 of the flashlight apparatus 12 is inserted through an opening in one of the monkey's arms, through the monkey's hollow body, and into available space in the monkey's other arm.

In another embodiment of the invention, the flashlight apparatus 12 includes a plurality of lighting units 24, and the plush cover 14 includes multiple openings 22 for exposing the illumination produced by the lighting units 24. For example, the flexible, plush light of the invention can be shaped after an octopus with multiple arms, each arm configured to receive and cover the flexible elongated body 26, with openings formed at the terminal end of each arm, suitable for exposing the illuminating end of one or more lighting units 24. The same concept can be applied to include multiple lighting units 24 within the body of a stuffed animal toy where the arms and the head are configured to receive one or more lighting units 24, therein.

The invention may be produced in various sizes. In certain embodiments of the invention, the invention may be configured for use as a reading light attachable to a book. For example, the flashlight apparatus 12 may be manufactured in miniature size, so it is small and light enough to be attached by way a clip or other means to the side of a book or other reading material. In some embodiments, the invention may be attached to the reading material by way of its flexible elongated body 26, for example, by bending the body as a hook to removably latch on to the middle portion of the book.

The present invention also provides a flexible plush body cover that may be in the form of a toy animal and that is also capable of receiving an item in the body cover, such as a lighting apparatus. A standard lighting apparatus, for example a flashlight having a flexible body, can be inserted into a toy animal to provide a decorative and aesthetically pleasing cover. In one embodiment, the toy animal includes a flexible elongated tube with a head portion on one end and an opening in the head portion simulating a mouth. A lighting apparatus having a flexible elongated body and a lighting unit on one end of the lighting apparatus is removably insertable into the opening in the head portion, such that the flexible elongated body fits into the flexible tube. The lighting unit partially protrudes through the opening in the head portion to provide illumination. A looped portion 18 may also be included and disposed on an end of the flexible elongated tube opposite the head portion. The looped portion 18 is provided for ease of carrying or holding the body cover and for attaching a key-holding device, such as a key chain.

Thus, a flexible, plush light according to one or more embodiments of the invention is described. While only a number of embodiments consistent with the present invention have been described, those skilled in the art will understand that various changes and modifications may be made to these embodiments, and equivalents may be substituted for elements in these embodiments, without departing from the true scope of the invention. For example, as described above, the flexible, plush light of the invention can be modified to include a plurality of lighting units disposed in various ends of the plush cover, or can be configured for use with a key chain.

In addition, modifications may be made to adapt a particular element, technique or implementation to the teachings of the present invention without departing from the central scope of the invention. For example, the plush cover of the present invention can be modified in various sizes, forms and shapes, or can include multiple body members for housing one or more lighting units therein. Therefore, this invention should not be limited to the particular embodiments and methods disclosed in this application, but should include all embodiments that fall within the scope of the appended claims.

While the specification describes particular embodiments of the present invention, those of ordinary skill can devise variations of the present invention without departing from the inventive concept.

What is claimed is:

1. A flexible lighting apparatus, comprising:
a flashlight comprising a lighting unit, and a flexible, elongated body attached to said lighting unit, said elongated body manipulatable to freely conform to various shapes; and
a decorative cover, having at least one opening configured to receive the flashlight's lighting unit, and a partly hollow body configured to house said elongated body,
wherein the elongated body of the flashlight is insertable into the decorative cover's partly hollow body through said at least one opening in said decorative cover, such that at least a portion of the flashlight's lighting unit protrudes out of said at least one opening.

2. The flexible lighting apparatus of claim 1, wherein the flexible, elongated body includes a flexible core.

3. The flexible lighting apparatus of claim 2, wherein the flexible, elongated body further includes a flexible resilient sleeve about the flexible core.

4. The flexible lighting apparatus of claim 1, wherein the at least one opening of the decorative cover simulates the mouth of a stuffed toy animal.

5. The flexible lighting apparatus of claim 1, wherein the hollow body of the decorative cover resembles the body of a stuffed toy animal.

6. The flexible lighting apparatus of claim 1, wherein the flashlight can be activated by axially rotating the lighting unit.

7. The flexible lighting apparatus of claim 1, wherein the flashlight can be activated by means of a pressure activated switch concealed within the decorative cover.

8. The flexible lighting apparatus of claim 1, wherein said flashlight further includes a compartment for storing one or more power sources.

9. The flexible lighting apparatus of claim 8, wherein said cover includes a means for accessing said compartment as the flashlight remains inserted in the plush body of the decorative cover.

10. The flexible lighting apparatus of claim 9, wherein the decorative cover includes a head portion, resembling the head of a stuffed toy animal, said head having at least one opening so that the flashlight's lighting unit is disposed therein.

11. The flexible lighting apparatus of claim 10, wherein the partly hollow body of the decorative cover resembles the plush body of a stuffed toy animal having one or more body members such that the flashlight's flexible body is disposed within one or more of said body members.

12. The flexible lighting apparatus of claim 1, wherein the flexible, elongated body further includes a coil spring about the flexible core.

13. The flexible lighting apparatus of claim 1, configured for use as a reading light that is small in size and includes means for connecting to the side of a reading material.

14. The flexible lighting apparatus of claim 1, configured for use with a key chain.

15. A flexible lighting apparatus, comprising:
a lighting apparatus comprising one or more lighting units, attached to one or more flexible, elongated bodies manipulatable to freely conform to various shapes; and
a decorative cover, having one or more openings configured to receive said one or more lighting units, and a partly hollow body configured to house said one or more elongated bodies,
wherein said one or more elongated bodies are insertable into the decorative cover, such that at least a portion of said one or more lighting units is respectively exposed out of said one or more openings.

16. The flexible lighting apparatus of claim 15, wherein the decorative cover resembles a stuffed toy animal, such that said at least one of said one or more openings simulates the mouth of the stuffed toy animal.

17. The flexible lighting apparatus of claim 15, wherein the flexible, elongated body further includes a coil spring about the flexible core.

18. The flexible lighting apparatus of claim 15, configured for use as a reading light that is small in size and includes means for connecting to the side of a reading material.

19. The flexible lighting apparatus of claim 15, configured for use with a key chain.

20. A flexible plush stuffed toy animal, the toy animal including at least one body part and at least one lighting unit, the at least one lighting unit disposed at a terminal end of said at least one body part.

21. A flexible, plush body cover comprising:
a flexible tube having an outside covered by a plush decorative covering, the flexible tube being capable of supporting an item placed inside the flexible tube; and
a head portion covering a second end of the flexible tube, the head portion having an opening simulating a mouth of a toy animal.

22. The flexible, plush body cover of claim 21, further comprising a lighting apparatus having a flexible elongated body and a lighting unit disposed on one end of the flexible elongated body, the flexible elongated body being removably insertable into the flexible tube.

23. The flexible, plush body cover of claim 21, wherein the opening in said head portion is capable of receiving a lighting apparatus having a flexible elongated body and a lighting unit, the lighting unit partially protruding through the opening in the head portion to provide illumination.

24. The flexible, plush body cover of claim 21, wherein the flexible tube further comprises a second opening at an opposite end from said head portion, the second opening for allowing access to an item placed inside said flexible tube.

25. The flexible plush body cover of claim 21, further comprising a looped portion disposed on an end of the flexible tube opposite said head portion, the looped portion for holding the body cover.

26. The flexible, plush body cover of claim 21, further comprising a looped portion disposed on end of the flexible tube opposite said head portion, the looped portion for attaching a key-holding device.

27. A method of enclosing a lighting apparatus with an aesthetically pleasing body cover, the method comprising:
sliding a flexible elongated body of the lighting apparatus into a flexible tube, the flexible tube having a plush decorative body cover and head portion disposed on one end; and
placing a lighting unit of the lighting apparatus in the head portion, the head portion having an opening through which the lighting unit partially protrudes and through which the flexible elongated body is inserted into the tube.

28. The method of claim 27, further comprising allowing additional access to the flexible tube by including an opening on an end of said flexible tube opposite said head portion.

29. The method of claim 27, further comprising attaching a looped portion to an end of the flexible tube opposite said head portion, the looped portion for carrying the body cover.

30. The method of claim 27, further comprising attaching a looped portion to an end of the flexible tube opposite said head portion, the looped portion for attaching a key-holding device.
